(19) United States
(12) Patent Application Publication
(10) Pub. No.: US 2010/0285436 A1
(43) Pub. Date: Nov. 11, 2010

(54) System, method, and apparatus for a portable, combination incubator, dehydrater, and micropropgation science unit

(76) Inventor: Trisha Beth DeVore, Batavia, IA (US)

Correspondence Address: Trisha DeVore, 1014180th Street, Batavia, IA, 52533, US

(21) Appl. No.: 12/008,299

(22) Filed: Jan. 9, 2008

(51) Int. Cl. G09B 23/02; G09B 23/00

(52) U.S. Cl. 434/188; 434/276

(57) ABSTRACT

The present invention is a system, method that uses a cost-effective, portable, combination unit that can function as an incubator, dehydrator, and micro-propagation apparatus in the school classroom, at home, in an industrial setting, in a homeland security setting, in a forensic environment, and in the field for culturing, growing, blooming, propagating, and micro-propagating of various plants. In addition, the combination science unit can be use with bio-tissue.

### CROSS-REFERENCE TO RELATED APPLICATIONS

This application is a conversion of and claims priority to prior U.S. Provisional Patent Application Ser. No. 60/879,089 SYSTEM, METHOD, AND APPARATUS FOR A PORTABLE, COMBINATION INCUBATOR, DEHYDRATER, AND MICROPROPGATION SCIENCE UNIT filed on Jan. 8, 2007, which is herein incorporated by reference in its entirety.

### BACKGROUND OF THE INVENTION

1. Field of the Invention

The present invention relates generally to the study of various branches of earth science, including, but not limited to, botany, biology, and horticulture. The present invention, also known as a Tri Science Hobby Appliance—which is based on the inventor's first name—Trisha (TriSHA), is suitable for use by students, teachers, scientists, homeland security agents, FBI, CIA, and police departments for forensics, health departments and personnel, farmers, and home hobbyists. More particularly, though not exclusively, the present invention is a system and method that employs a cost-effective, portable, combination unit that can function as an incubator, dehydrator, and micro-propagation apparatus in the school classroom, at home, in an industrial setting, in a homeland security setting, in a forensic environment, and in the field for culturing, growing, blooming, propagating, and micro-propagating of various plants. In addition, the combination science unit can be use with bio-tissue.

2. Problems in the Art

There is an unfilled need for a system, method, and apparatus which solves the problem of cost, portability, modularity, and other problems associated with incubators, dehydrators, and micro-propagation units. The present invention has as its primary objective fulfillment of these needs.

### FEATURES OF THE INVENTION

A general feature of the present invention is the provision of a system, method, and apparatus for a cost-effective, portable, combination unit for the study of various branches of science, including, but not limited to, botany and biology, which overcomes the problems found in the prior art.

A feature of the present invention is the provision of a combination science unit that can function as an incubator, dehydrator, and micro-propagation unit.

A further feature of the present invention is a combination science unit that is cost-effective.

A further feature of the present invention is a combination science unit that is of sufficient quality to be used by scientists as well as students, and home hobbyists.

A further feature of the present invention is a combination science unit that is portable.

A further feature of the present invention is a combination science unit that is lightweight.

A further feature of the present invention is a combination science unit that is collapsible.

A further feature of the present invention is a combination science unit that is modular.

A further feature of the present invention is a combination science unit that can be outfitted with optional features.

A further feature of the present invention is a combination science unit that can be outfitted with optional features, such as a heat mat.

A further feature of the present invention is a combination science unit that can be outfitted with optional features, such as a heat mat that can be used with a temperature controller.

A further feature of the present invention is a combination science unit that can be outfitted with optional features, such a second, raised, removable floor when used in conjunction with a heat mat.

A further feature of the present invention is a combination science unit that is of a quality that it can be used by scientists in the laboratory.

A further feature of the present invention is a combination science unit that is of a quality that it can be used by scientists in the field.

A further feature of the present invention is a combination science unit that is of a quality that it can be used by industrialists in a commercial laboratory.

A further feature of the present invention is a combination science unit that is of a quality that it can be used by industrialists in a commercial production setting.

A further feature of the present invention is a combination science unit that is of a quality and cost that it can be used by home hobbyists at home.

A further feature of the present invention is a combination science unit that is of a quality that it can be used by teachers and students in public, parochial, and home classroom settings.

A further feature of the present invention is a combination science unit that is designed to be used in conjunction with science curriculum in elementary schools, middle school, high schools, home schools, trade schools, two-year colleges, four-year colleges, and post-graduate schools and colleges.

A further feature of the present invention is a combination science unit that is designed to be used in conjunction with science curriculum that is printed in a supplementary pamphlet, leaflet, brochure, guide, notes, or text book.

A further feature of the present invention is a combination science unit that is designed to be used in conjunction with science curriculum that is available on-line in a supplementary pamphlet, leaflet, brochure, guide, notes, or text book.

A further feature of the present invention is a combination science unit that can be outfitted with a fogger for humidification of the chamber.

A further feature of the present invention is a combination science unit that uses standard, off-the-shelf, replaceable air filters.

A further feature of the present invention is a combination science unit that can be outfitted with an optional light fixture for use with a grow light bulb, or ultraviolet light bulb.

A further feature of the present invention is a combination science unit that uses low to medium-tech components to operate at high-tech parameters.

A further feature of the present invention is a combination science unit that provides a controlled environment, including temperature, humidity, light, air pressure, and air purity.

A further feature of the present invention is a combination science unit that generally is comprised of an air-flow chamber, and an open-ended environmental chamber.

A further feature of the present invention is a combination science unit that generally is comprised of an air-flow chamber, and an open-ended environmental chamber that can be closed off on the open end, and a drip shield with holes placed in the environmental chamber after the laminar air flow chamber's outflow filter to create a humid environment when used in conjunction with humidifying fogger.

A further feature of the present invention is a combination science unit that uses clocks/timers on the laminar air flow chamber's fan and blower motor 103 and an optional humidifying fogger and heat mat in the environmental chamber to mimic the daily cycle of heat and moisture by cycling the fan and blower motor 103, humidifying, fogger, and heat mat as appropriate.

A further feature of the present invention is a combination science unit that optionally includes sensors for humidity, temperature, air flow, and air quality.

A further feature of the present invention is a combination science unit that optionally includes a data port for upstream and downstream hard-wired or wireless communications with a device, such as, but not limited to, a laptop, PC, PDA, tablet, smart phone, etc.

A further feature of the present invention is the provision of a method to reverse the flow of the fan and blower motor 103 in the laminar flow hood.

A further feature of the present invention is a combination science unit that optionally includes a clock/timer for turning the fan and blower motor 103 in the laminar flow hood off and on at pre-determined times when the unit is unattended.

A further feature of the present invention is the provision of a method to variably control the speed of the fan and blower motor 103 in the laminar flow hood to speeds that produce an airflow that exceeds 100 cfm for sterile environments in the environmental chamber.

A further feature of the present invention is a combination science unit that optionally includes a clock/timer for turning the optional heating mat in the environmental chamber off and on at pre-determined times when the unit is unattended.

A further feature of the present invention is a combination science unit that optionally includes a clock/timer for turning the optional humidifying fogger in the environmental chamber off and on at pre-determined times when the unit is unattended.

A further feature of the present invention is a combination science unit that optionally includes the used of a desiccant when the unit is being used a dehydrator.

A further feature of the present invention is a combination science unit that optionally includes an environmental chamber constructed out of UV resistant material.

A further feature of the present invention is a combination science unit that optionally includes an environmental chamber covered with removable UV resistant materials.

A further feature of the present invention is a combination science unit that optionally includes an environmental chamber that includes magnets on the front edges of the open end that can be used for attached a front cover that also includes magnets.

One or more of these and/or other features and advantages of the present invention will become apparent from the following specification and claims.

### BRIEF DESCRIPTION OF THE DRAWINGS

FIG. 1 illustrates the present invention.

### SUMMARY OF THE INVENTION

The present invention relates generally to the study of various branches of earth science, including, but not limited to, botany, biology, and horticulture. The present invention is suitable for use by students, teachers, scientists, homeland security agents and scientists, FBI, CIA, and police department personnel and scientists, health departments and personnel, and home hobbyists. More particularly, though not exclusively, the present invention is a system and method that employs a cost-effective, portable, combination unit that can function as an incubator, dehydrator, and micro-propagation apparatus in the school classroom, at home, in an industrial setting, and in the field for culturing, growing, blooming, propagating, and micro-propagating of various plants. In addition, the combination science unit can be used with bio-tissue growth and experiments.

### DETAILED DESCRIPTION OF THE INVENTION

The present invention relates generally to the study of various branches of earth science, including, but not limited to, botany, biology, and horticulture. The present invention is suitable for use by students, teachers, scientists, homeland security agents and scientists, FBI, CIA, and police department personnel and scientists, health departments and personnel, and home hobbyists. More particularly, though not exclusively, the present invention is a system and method that employs a cost-effective, portable, combination unit that can function as an incubator, dehydrator, and micro-propagation apparatus in the school classroom, at home, in an industrial setting, and in the field for culturing, growing, blooming, propagating, and micro-propagating of various plants. In addition, the combination science unit can be used with bio-tissue growth and experiments.

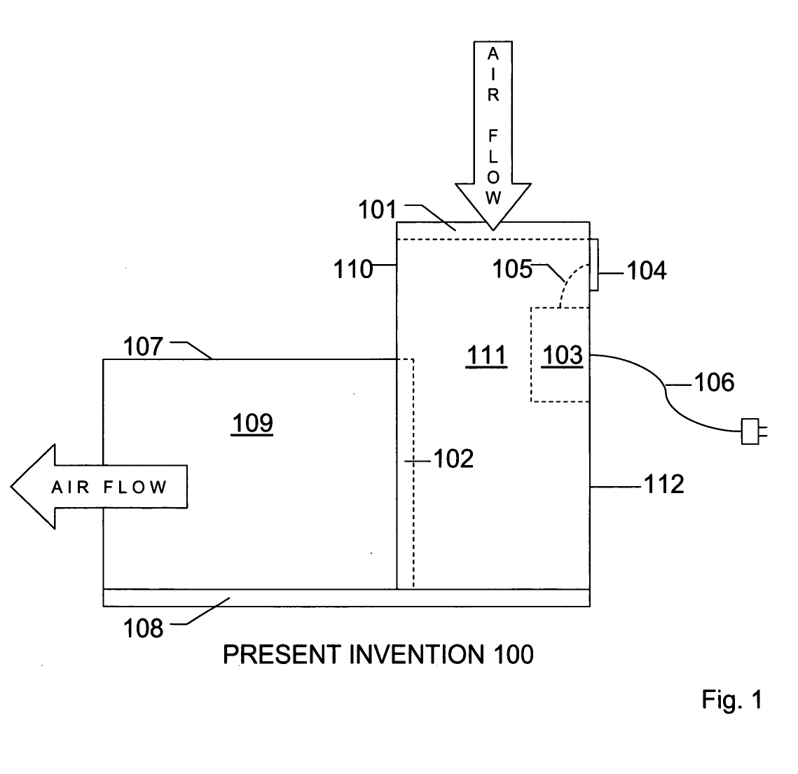

FIG. 1 illustrates the present invention. According to one aspect of the present invention 100 a flow hood, specifically a laminar flow hood, is provided. A laminar flow hood, also known as a laminar flow cabinet or laminar flow closet, is a carefully designed air flow chamber that is designed to prevent contamination. The laminar flow hood is constructed of side 110, connected to side 111, connected to side 112 connected to side 111 (not shown) on the opposite of side 111 which is shown, connected to side 110. Laminar flow, sometimes known as streamline flow, occurs when a fluid flows in parallel layers, with little or no disruption between the layers. In fluid dynamics, laminar flow is a characterized by high momentum diffusion, low momentum convection, and pressure and velocity independence from time. It is the opposite of turbulent flow. In nonscientific terms laminar flow is “smooth,” while turbulent flow is “rough.” Laminar flow is important in the present invention for maintaining a sterile work setting in the environmental chamber.

Intake air is drawn through a first intake filter 101 and blown in a very smooth, or what is known as a laminar flow, toward a second filter, or the outflow air filter 102, into the environmental chamber of the combination science unit. The direction of the air flow through the present invention 100 is shown by the two arrows labeled “air flow”. The sides 110, 111 (shown), 112, 111 (not shown) of the laminar air flow chamber are usually made of a material that is not prone to the collection and growth of molds or other contaminants, and is also constructed with little or no gaps or joints where mold spores or other contaminants might grow and collect. The laminar flow hood can be implemented in either a horizontal or vertical configuration. Optionally, a laminar flow hood may include one or more UV-C germicidal lamps (not shown) to sterilize the laminar air flow when not in use, and also to purify the outflow air into the environmental chamber when in use.

The laminar flow hood used in the present invention is a vertical hood, which intakes un-filtered/un-purified air vertically and discharges filtered air horizontally. The laminar flow hood is generally square in cross-section and rectangular in height and width, and includes an air intake filter at the top of the laminar flow hood. In addition, a fan and blower motor combination 103 is mounted inside the laminar flow hood attached to one of the sides 110, 111 (shown), 112, 111 (not shown), which is connected to an electrical power source through power cord 106 and switch 104.

In a unique aspect of the present invention, the air intake filter 101 and air outflow filter 102 are commercially available home furnace filters. The air intake filter 101 can be a standard furnace filter, or a HEPA Filter. The air outflow filter 102 is a HEPA (High Energy Particulate Air [filters]). These types of filters as defined by the United states Department of Energy This type of air filter can theoretically remove at least 99.97% of dust, pollen, mould, bacteria and any airborne particles with a size of 0.3 micrometers (μm) at 85 liters per minute (L/min). The diameter specification of 0.3 μm responds to the worst case; the most penetrating particle size (MPPS). Particles that are larger or smaller are trapped with even higher efficiency. Using the worst case particle size results in the worst case efficiency rating (i.e. 99.97% or better for all particle sizes).

HEPA filters are composed of a mat of randomly arranged fibers. The key metrics affecting the function of the HEPA filter are fiber density and diameter, and filter thickness. The air space between HEPA filter fibers is much greater than 0.3 μm. HEPA filters are designed to target smaller pollutants and particles, and are mainly trapped by sticking to the filter fiber by one of the following three mechanisms: 1) interception, where particles following a line of flow in the air stream come within one radius of a fiber and adhere to it, 2) Impaction, where larger particles are unable to avoid fibers by following the curving contours of the air stream and are forced to embed in one of them directly; this increases with diminishing fiber separation and higher air flow velocity, and 3) .Diffusion, an enhancing mechanism which is a result of the collision with gas molecules by the smallest particles, especially those below 0.1 μm in diameter, which are thereby impeded and delayed in their path through the filter; this behavior is similar to Brownian motion and raises the probability that a particle will be stopped by either of the two mechanisms above; it becomes dominant at lower air flow velocities.

Diffusion is the predominant method for trapping particles below the 0.1 μm diameter. Impaction and interception are predominant method for trapping particles above 0.4 μm in diameter. In between, near the 0.3 μm MPPS, diffusion and interception are the predominant method for trapping particles.

Optionally, ULPA (Ultra Low Penetration Air) filters can be used with the present invention. An ULPA filter is designed to theoretically remove from the air at least 99.999% of dust, pollen, mold, bacteria and any airborne particles with a size of 0.12 micrometers or larger.

In addition, a SULPA (Super ULPA) filters can be used with the present invention. A SULPA filter is designed to theoretically remove up to 99.9999% of dust, pollen, mold, bacteria and any airborne particles with a size of 0.12 micrometers or larger.

In another unique aspect of the present invention, the fan and blower motor 103 in the laminar air flow chamber is specified to move a minimum of 100 cfm (cubic feet per minute) of air through the outflow air filter and into the environmental chamber. The airflow volume has been chosen to maintain a high number of air changes per minute in the environmental chamber, which helps maintain a very sterile environment in the environmental chamber. As an example, the Center for Disease Control (CDC) recommends a minimum of 12 air changes per hour for air that is recirculated in a hospital room or building in order to ensure a minimum standard of air quality. Assuming a 10 cubic foot environmental chamber is being used in the present invention, a 100 cfm blower would provide 10 air changes per minute, which exceeds the CDC requirements for recirculated air in a hospital environment by a factor of 50. The high air flow reduces the total time that any airborne contaminants are in contact with any substance in the present invention's environmental chamber. In addition, the blower provides a slightly positive air pressure (positive meaning an air pressure reading slightly above the ambient atmosphere's barometric reading) in the environmental chamber, which means outside air that has not been filtered by the two HEPA filters in the laminar air flow chamber cannot infiltrate the environmental chamber.

In another unique aspect of the present invention, the laminar air flow chamber is designed to be modular, in other words the laminar air flow chamber is not a monolithic unit that includes the environmental chamber. The modular laminar air flow chamber is collapsible, which gives it unprecedented portability into the field, or for storage in a small area when not in use. The collapsible feature for the laminar air flow hood can be provided by a number of methods. As an example, one method for providing collapsibility is through the use of extruded or molded edges to join the vertical edges of the laminar air flow chamber together for use. These extruded or molded edges can be made of a variety of materials, such as, but not limited to, metal, plastic, etc. As a another example of a method for collapsibility is through the use of hinges to join the four vertical edges of the laminar air flow together like an accordion, in conjunction with the use of hinges on the vertical centerline of two opposite sides, which would allow the laminar air flow chamber to collapse upon itself when a modular approach is used for attaching the fan and blower motor 103 to one of the sides using a quick release apparatus. As a third example of a method for collapsibility is through the use of hinges to join the four vertical sides 110, 111 (shown), 112, 111 (not shown) of the laminar air flow together like an accordion, in conjunction with the use of hinges on the vertical centerline of two opposite sides, which would allow the laminar air flow chamber to collapse upon itself when the fan and blower motor 103 is positioned such that when the laminar air flow chamber is collapsed it protrudes through the outflow air filter opening in the opposite side on which the fan and blower motor 103 is mounted. In this example, the fan and blower motor 103 can still be attached in a modular way to one of the sides 110, 111 (shown), 112, 111 (not shown) of the laminar air flow chamber, but doesn't have to be removed for transport or storage.

In another unique aspect of the present invention, the laminar air flow chamber is designed to accept standard, off-the-shelf HEPA intake and outflow filters 101, 102 designed for use with home or commercial buildings HVAC systems. This approach keeps the initial cost of the present invention to a minimum, as well as keeping the on-going operational costs of the present invention to a minimum. In addition, this approach would allow the present invention to be transported for use in the field without having to transport the necessary HEPA filters, as they could be purchased at a wide variety of stores, such as a hardware store, or major lumberyard like Home Depot, etc., which are local to the place that the present invention is going to be assembled and used. Alternatively, a method for providing collapsibility through disassembly of the sides of the laminar air flow chamber is through the use of hinges that are joined using removable pins, such as, but not limited to, a cotter pin, a detent pin, a hitch pin, a klik pin, etc. In this example as previously described, the blower could be mounted in a modular method for easy removal for disassembly. The fan and blower motor 103 could be mounted opposite the side with the outflow air filter opening such that it would protrude through the opening when the laminar air flow chamber is collapsed.

In all of the aforementioned methods employing hinges for collapsibility, the hinges can be mounted on inside or outside corners, or combinations of inside and outside corners.

Another method for providing collapsibility through disassembly is by the provision of quick assembly-disassembly joint that are molded, extruded, or machine that allow the joining of the vertical edges of the laminar air flow chamber by sliding them into slots in the quick assembly-disassembly joints. These joints can be made out of any material, preferably plastic or metal.

The sides 110, 111 (shown), 112, 111 (not shown) of the laminar air flow chamber can be made from a wide variety of materials including steel, stainless steel, aluminum, or any other metal, plastic, vinyl, Plexiglas, marine grade plywood, etc. In addition, the sides of the open-ended environmental chamber can be made of laminated materials. As an example, the sides may be wood, structural honeycomb, etc, that are faced on one or both sides with sheet metal, fiberglass reinforced panel (FRP), high pressure laminate (HPL), melamine, polystyrene, Formica, etc. When steel is used it can be natural finish, or painted. Paint may be an epoxy, urethane, or polyester, or hybrid paint. Conductive metals may be powder coated, which is an electrostatic application process which is completed with a baking operation. Or, the paint may be electostatically applied to a conductive metal without the baking operation.

The 100 cfm minimum air flow requirement can be provided by a single 100 cfm or greater fan and blower motor, or multiple fan and blower motors of smaller air flow capacity. As an example, two 50 cfm motors can be used in parallel to provide a total of 100 cfm air flow through the laminar air flow chamber into the environmental chamber of the present invention. The fan and blower 103 can be mounted in a modular fashion through a variety of methods, including, but not limited to, 1) using removable locking pins through the mounting holes in a typical blower to attach the unit to holes that match the pattern of the blower, which are located in one of the sides 110, 111 (shown), 112, 111 (not shown) of the laminar air flow chamber, 2) attaching the blower to a shoe that can be slid in and out of troughs that are mounted to the sides 110, 111 (shown), 112, 111 (not shown) of the laminar air flow chamber, and 3) by using nuts, bolts and washers to attach the blower unit by the mounting holes to holes in one of the sides 110, 111 (shown), 112, 111 (not shown) of the laminar flow hood that match the hole pattern of the blower. The power for the fan and blower motor 103 is provided through a plug 106 connected to an electrical outlet and controlled by switch 104. The power source can be standard house or commercial building wiring, via a portable generator if the present invention is used in the field, or via a vehicle that has a power inverter if the present invention is used in the field, etc.

The HEPA filters are designed to fit snuggly into place into ductwork sleeve (not shown) that creates an interface for the filter to one of the vertical sides 110, 111 (shown), 112, 111 (not shown) of the laminar air flow chamber, or the open top of the laminar air flow chamber. The sleeve may be designed to accommodate shims to force the filter to fit the ductwork sleeve tightly to largely prevent the flow of unfiltered air around the HEPA filter and into the environmental chamber. In addition, the sleeve may include a soft-seal that is designed to conform to the HEPA filter's irregularities and thereby largely prevent the flow of unfiltered air around the HEPA filter and into the environmental chamber.

Optionally, the air intake filter 101 and air outflow filter 102 can be used in conjunction with additional pre- and post-filters to provide additional air filtration.

The second major component of the present invention is the open-ended environmental chamber. The environmental chamber is constructed of sides 109 (shown) connected to side 107 (shown) connected to side 109 (not Shown) connected to side 107 (not shown). This component is generally square in cross-section and rectangular in length and width, and is connected to the laminar air flow chamber at the air outflow HEPA filter.

In another unique aspect of the present invention, the open-ended environmental chamber is designed to be modular, in other words the open-ended environmental chamber is not a monolithic unit that includes the environmental chamber. The modular open-ended environmental chamber is collapsible, which gives it unprecedented portability into the field, or for storage in a small area when not in use. The collapsible feature for the open-ended environmental hood can be provided by a number of methods. As an example, one method for providing collapsibility is through the use of extruded or molded edges to join the horizontal edges of the open-ended environmental chamber together for use. These extruded or molded edges can be made of a variety of materials, such as, but not limited to, metal, plastic, etc. As a another example of a method for collapsibility is through the use of hinges to join the four horizontal edges of the open-ended environmental together like an accordion, in conjunction with the use of hinges on the horizontal centerline of two opposite sides, which would allow the open-ended environmental chamber to collapse upon itself when a modular approach is used for attaching the fan and blower motor 103 to one of the sides using a quick release apparatus. As a third example of a method for collapsibility is through the use of hinges to join the four horizontal edges of the open-ended environmental chamber together like an accordion, in conjunction with the use of hinges on the horizontal centerline of two opposite sides, which would allow the open-ended environmental chamber to collapse upon itself when the fan and blower motor 103 is positioned such that when the open-ended environmental chamber is collapsed it protrudes through the outflow air filter opening in the opposite side on which the fan and blower motor 103 is mounted. In this example, the fan and blower motor 103 can still be attached in a modular way to one of the sides of the laminar flow chamber, but doesn't have to be removed for transport or storage.

In all of the aforementioned methods employing hinges for collapsibility, the hinges can be mounted on inside or outside corners, or combinations of inside and outside corners.

Another method for providing collapsibility through disassembly is by the provision of quick assembly-disassembly joint that are molded, extruded, or machine that allow the joining of the horizontal edges of the open-ended environmental chamber by sliding them into slots in the quick assembly-disassembly joints. These joints can be made out of any material, preferably plastic or metal.

The sides 107 (shown and not shown), 109 (shown and not shown) of the open-ended environmental chamber can be made from a wide variety of materials including steel, stainless steel, aluminum, or any other metal, plastic, vinyl, Plexiglas, marine grade plywood, etc. In addition, the sides 107 (shown and not shown), 109 (shown and not shown) of the open-ended environmental chamber can be made of laminated materials. As an example, the sides 107 (shown and not shown), 109 (shown and not shown) may be wood, structural honeycomb, etc, that are faced on one or both sides with sheet metal, fiberglass reinforced panel (FRP), high pressure laminate (HPL), melamine, polystyrene, Formica, etc. When steel is used it can be natural finish, or painted. Paint may be an epoxy, urethane, or polyester, or hybrid paint. Conductive metals may be powder coated, which is an electrostatic application process which is completed with a baking operation. Or, the paint may be electostatically applied to a conductive metal without the baking operation.

Some of the optional features that can be included in the open-ended environmental chamber are 1) a fogger (not shown) to create a humid environment (this fogger can include a humidity sensor to modulate its operation), 2) a heat mat (not shown) for reducing the humidity in the environmental chamber and to create a higher temperature in the open-ended environmental chamber than might be available in the ambient air temperature surrounding the present invention, 3) a UV light (not shown), 4) a grow light (not shown), 5) environmental sensors (not shown), 6) a hard-wired or wireless data link (not shown), and 7) horizontal supports for slide-out shelving and the associated slide-out shelving in the environmental chamber (not shown).

The modular laminar air flow chamber and open-ended environmental chamber rest closely together when placed on a bottom tray 108, which is the third major modular component of the present invention.

The bottom tray 108 can be made from a wide variety of materials including steel, stainless steel, aluminum, or any other metal, plastic, vinyl, Plexiglas, marine grade plywood, etc. In addition, the sides of the open-ended environmental chamber can be made of laminated materials. As an example, the sides may be wood, structural honeycomb, etc, that are faced on one or both sides with sheet metal, fiberglass reinforced panel (FRP), high pressure laminate (HPL), melamine, polystyrene, Formica, etc. When steel is used it can be natural finish, or painted. Paint may be an epoxy, urethane, or polyester, or hybrid paint. Conductive metals may be powder coated, which is an electrostatic application process which is completed with a baking operation. Or, the paint may be electostatically applied to a conductive metal without the baking operation.

In addition, the entire combination science unit may include a fuse box (not shown), an integrated power strip (not shown) for plugging in the fan and blower motor 103, optional lights (not shown), and a heat mat (not shown),

Although the present invention is designed to provide and maintain a sterile environmental chamber using cleaning procedures involving Quatricide, or a similar disinfectant, the present invention can be used in conjunction with a contamination control procedures in accordance with MIL-STD-1246. Detailed requirements conform to the requirements of FED-STD-209 for monitoring air cleanliness. The following documents, of the latest issue in effect, except as otherwise indicated, form a part of this specification to the extent specified. In the event of conflict between documents referenced herein and the contents of this specification, the contents of this specification shall take precedence, including FED-STD-209E, entitled Airborne Particulate Cleanliness Classes in Cleanrooms and Clean Zones, and MIL-STD-1246C, entitled Product Cleanliness Levels and Contamination Control. Additional quality control procedures may be employed to establish and maintain contamination control as needed.

In addition to being completely modular and collapsible, the environmental chamber can be non-collapsible, and include a handle on one of the sides for ease in picking the unit up and transporting it. In this scenario, the environmental chamber can be collapsed and stored in the laminar air flow chamber, and the bottom try 108 that is integral with the laminar air flow chamber can be hinged at the edge where the environmental chamber meets the laminar air flow chamber, so that the bottom try 108 can fold up and be locked against the laminar air flow chamber for storage and transportation. In addition, in this scenario, the laminar air flow chamber can be used to store supplies that are used with the present invention, such as, but not limited to Petri dishes, test tubes, flasks, instructions, etc.

In all embodiments of the present invention, a manufacturers tag (not shown) is affixed to the unit that displays items such as, but not limited to, a serial number, a model number, a UL or CE mark, warnings, etc. This tag may include information encoded in a bar code or RFID tag.

In addition to the cost-effectiveness, modularity, collapsibility, and portability of the present invention, the most unique aspect is the use of the present invention in conjunction with public, private, parochial, or home-based education scenarios. These education scenarios can be elementary schools, middle school, high schools, home schools, trade schools, two-year colleges, four-year colleges, and post-graduate schools and colleges. The present invention is designed to be used in conjunction with a wide variety of printed educational materials, including, but not limited to a supplementary pamphlet, leaflet, brochure, guide, notes, or incorporated within a text book. Furthermore, the curriculum can be on-line material that is available for download, or as a database that is used to draw together students participating in the same or similar experiments across a wide geographic area. The website that contains the on-line education material and curriculum can include all the usual features, including, but not limited to, an on-line store, live question and answer sessions, chat sessions, distance learning and teaching, class notes, teaching notes, how-to videos and pictures, etc.

The ultimate goal for the present invention is to have its teaching and learning opportunities integrated into a recognized curriculum publisher to increase student achievement in the previously mentioned earth sciences, including, but not limited to, botany, horticulture, and biology. The curriculum for the present invention will contain instructional activities for the combination science unit which will allow teachers and instructors to dramatically enhance the teaching of science concepts. The printed and/or on-line integrated curriculum would contain complete teaching notes, including objectives, classroom management notes and answers support the activities. Textbooks would include a CD-ROM that contained electronic data sheets for the exercises in the integrated curriculum, and also would contain electronic flash study cards to help students review each chapter in conjunction with the experiments they ran. The present invention will also integrate the widely used Texas Instruments TI-83/84 scientific calculators, which are already used in conjunction with integrated educational curriculum. Using this method, students will not only be learning science, but the related and equally important math skills that are necessary for performing data analysis, statistics, etc. Using such an integrated teaching system that uses exercises and experiments will provide teachers and instructors immediate feedback on their student's progress during the course of a lesson. The teachers and instructors can use this instantaneous feedback to adjust their instruction and ensure that all students make daily progress. The present invention will help make science and related mathematic education a much more rewarding and dynamic experience for the youth of today's world that grew up on instant feedback and gratification, and largely live life in an on-line environment.

### USES OF THE PRESENT INVENTION

One use for the combination science unit is for micropropagation. Micropropagation is the practice of rapidly multiplying stock plant material to produce a large number of progeny plants. Micropropagation is used to multiply novel plants, such as those that have been genetically modified or bred through conventional plant breeding methods. It is also used to provide a sufficient number of plantlets for planting from a stock plant which does not produce seeds, or does not respond well to vegetative propagation.

Micropropagation begins with the collection of a sterile explant(s). This small portion of plant tissue, which may be as small as a cell, is placed on a growth medium, typically a medium containing sucrose as an energy source and one or more plant growth regulators (plant hormones). Usually the medium is thickened with Agar to create a gel which supports the explant during growth. The plant tissue should now begin to grow and differentiate into new tissues. For example, media containing cytokinin are used to create branched shoots from plant buds.

Following the successful growth of plant tissue, the establishment stage may be repeated, by taking tissue samples from the plantlets produced in the first stage. Through repeated cycles of this process, a single cell sample may be magnified to hundreds or thousands of plants.

Next is the pretransplant stage, which involves treating the plantlets/shoots produced to encourage root growth and “hardening”. It is performed in vitro, or in a sterile “test tube” environment.

Root growth does not always occur in the earlier stages in plant cell culture, and is of course a requirement for successful plant growth after the micropropagation procedure. It is performed in vitro by transferring the plantlets to a growth medium containing auxin(s).

“Hardening” refers to the preparation of the plants for a natural growth environment. Until this stage, the plantlets have been grown in “ideal” conditions, designed to encourage rapid growth. Due to lack of necessity, the plants are likely to be highly susceptible to disease and will be inefficient in their use of water and energy.

Hardening typically involves slowly weaning the plantlets from a high-humidity, low light, warm environment to what would be considered a normal growth environment for the species in question.

This stage (pretransplant) is not always performed, instead being incorporated into the last stage by encouraging root growth and hardening ex vitro, or in non-sterile plant media.

In the final stage of plant micropropagation, the plantlets are removed from the plant media and transferred to soil or (more commonly) potting compost for continued growth by conventional methods. This stage is often combined with the “Pretransplant” stage.

Micropropagation has a number of advantages over traditional plant propagation techniques: 1) micropropagation produces disease-free plants, 2) micropropagation produces rooted plantlets ready for growth, rather than seeds or cuttings, 3) it has an extraordinarily high fecundity, producing thousands of propagules in the same time it would take a conventional technique to produce tens or hundreds, 4) it is the only viable method of regenerating genetically modified cells or cells after protoplast fusion, 5) it is a good way of multiplying plants which produce seeds in uneconomical amounts (if at all), and 6) micropropagation often produces more robust plants, leading to accelerated growth compared to similar plants produced by conventional methods.

The present invention can also be used a dehydrator. Dehydration is the process of removing moisture from an object.

In addition, the present invention can also be used as an incubator. Incubation in biology is the controlling of temperature, humidity, and other conditions in which a microbiological culture is being grown.

The present invention can be used to grow mushrooms in a sterile environment without the used of chemicals to ensure easy organic certification.

The present invention can be used for homeland security applications when an expensive, portable unit that can be used in the field to test for widespread terrorist attacks involving anthrax, waterborne pathogens, etc.

The present invention can be used by the FBI, CIA, and police departments for forensic uses.

The present invention can be used by health organizations in the field in the case of a widespread flu pandemic for growing cultures, and for mixing IV medicines in a sterile environment, etc.

The present invention can be used to study medicinal plants in the field.

The present invention can be used by farmers to grow alternative crops, and do value added farming activities, and to harden and strengthen plants at the base by growing them initially in the environmental chamber using the laminar air flow chamber's motor to sway the plants and thus strengthen the tissue at the base of the plant and give them better stand-ability.

The present invention can be used with the airflow in reverse as a dustless paint chamber for hobbyists.

The present invention and doctors as a sterile environment to keep their sterile tools and instruments ready for a procedure or operation.

The present invention can be used with the airflow in reverse as a dustless chamber for dentists working on casts, molds, temporaries, etc.

The present invention can be used for drying and preserving plants.

The present invention can be used as a butterfly hatchery.

The present invention can be used to do hydroponics in a sterile environment.

The present invention can be used to study plant genetics.

The present invention can be used to germinate seeds.

The present invention can be used for hybridization.

The present invention can be used for flasking orchids.

The present invention can be used for the mycological studies.

The present invention can be used as a tool in micro-credit and micro-finance to create socio-economic changes. Microcredit is the extension of very small loans (microloans) to the unemployed, to poor entrepreneurs and to others living in poverty who are not considered bankable. These individuals lack collateral, steady employment and a verifiable credit history and therefore cannot meet even the most minimal qualifications to gain access to traditional credit. Microcredit is a part of microfinance, which is the provision of a wider range of financial services to the very poor.

Microcredit is a financial innovation which originated in developing countries where it has successfully enabled extremely impoverished people to engage in self-employment projects that allow them to generate an income and, in many cases, begin to build wealth and exit poverty. Due to the success of microcredit, many in the traditional banking industry have begun to realize that these microcredit borrowers should more correctly be categorized as pre-bankable; thus, microcredit is increasingly gaining credibility in the mainstream finance industry and many traditional large finance organizations are contemplating microcredit projects as a source of future growth. Although almost everyone in larger development organizations discounted the likelihood of success of microcredit when it was begun in its modern incarnation as pilot projects with ACCION and Muhammad Yunus in the mid-1970s, the United Nations declared 2005 the International Year of Microcredit.

It should be understood that the various aspects of the present invention described herein can be combined in various ways, as would be apparent to one skilled in the art having the benefit of this disclosure. It should also be appreciated that various modifications, adaptations, and alternatives may be made. It is of course not possible to describe every conceivable combination of components for purposes of describing the present invention. All such possible modifications are to be included within the spirit and scope of the present invention which is to be limited only by the following claims.

What is claimed is:

1. A combination science unit that is designed to be cost-effective, modular, collapsible, and portable for use in conjunction with educational curriculum as an aid to teach science and related math to students.

2. A combination science unit that is designed to be cost-effective, modular, collapsible, and portable for use in conjunction with homeland security applications involving waterborne, airborne, and other pathogens.

3. A combination science unit that is designed to be cost-effective, modular, collapsible, and portable for use in conjunction with microcredit and microfinance applications.
